(19) United States
(12) Patent Application Publication
(10) Pub. No.: US 2003/0078863 A1
(43) Pub. Date: Apr. 24, 2003

(54) Discounted printing

(75) Inventor: Maurizio Pilu, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/272,978

(22) Filed: Oct. 18, 2002

(30) Foreign Application Priority Data
Oct. 19, 2001 (GB) 0125124.8

(51) Int. Cl. G06F 17/60

(52) U.S. Cl. 705/34

(57) ABSTRACT

There is disclosed a method for discounting printing, comprising a) receiving information about printing by a consumer of content that has been selected by the consumer for printing and specified by a content provider as printable at a discount; b) obtaining, for use in discounting printing consumables, an estimation of printing costs incurred by the consumer in said printing of the selected content; and c) preparing a bill, using said estimation, for billing a stakeholder in the content for said printing. There is also disclosed causing information to be provided in association with viewable content. The information communicates to a viewer that specified content, comprising or related to the viewable content, is printable by the consumer at a discount. The discount is directly related to costs incurred by the consumer in printing said specified content. The information may, for example, be provided in the form of a GUI element activatable by a user input device.

### FIELD OF INVENTION

The present invention relates generally to discounted printing. More particularly, but not exclusively, the invention relates to a method of discounting printing, a discounted printing service and various business methods.

### DESCRIPTION OF PRIOR ART

International Patent Application Publication Number WO-A1-01/02948 discloses allowing a printer's or a user's account to accumulate a credit balance and for all or a portion of this balance to be presented to the corresponding user or users as a collection of points. If the printer account has a credit balance, then the corresponding points may be redeemed by the user or users for particular products or services.

International Patent Application Publication Number WO-A1-01/02946 discloses a printer module having an account that contains data indicative of the usage of the printer. The account is debited with amortized capital costs and running costs of the printer and credited with fees earned via the printer. Any credit balance can be redeemed.

International Patent Application Publication Number WO-A1-00/76204, assigned to Hewlett-Packard Company, discloses a document delivery system for automatically printing a document on a printing device. When a print schedule indicates that a document should be printed, the document is automatically transmitted to the printing device. A user profile is stored that contains information about a recipient of the document. The user profile can be used to select advertising to be included in the document. A product can be subsidized for a user, based on the information contained in the user profile. For, example, of a user profile indicates that a user has printed a number of preferred documents, a product such as an ink consumable can be sent to the user.

International Patent Application Publication Number WO-A1-01/84429 relates to the assembly, configuration and distribution of printed advertising. A printable paper sheet bearing advertising, for example in the margins, is downloaded from the internet for general use by any interested party. The user can register with an intermediary to receive such general or specific advertising from his computer related printing device. As consideration the user receives credits or points based e.g. on the number of pages or ads printed.

### SUMMARY OF THE INVENTION

In accordance with the invention, there is provided a method for discounting printing, comprising:

a) receiving information about printing by a consumer of content that has been

i) selected by the consumer for printing and

ii) specified by a content provider as printable at a discount;

b) obtaining, for use in discounting printing consumables, an estimation of printing costs incurred by the consumer in said printing of the selected content; and

c) preparing a bill, using said estimation, for billing a stakeholder in the content for said printing.

In accordance with a further aspect of the invention, there is provided a discounted printing service, for facilitating discounted printing of content by a consumer on printing apparatus for which the consumer is financially responsible, comprising:

a) receiving information about printing by the consumer of selected content which has been specified by a content provider as discounted printing content;

b) billing the content provider, or other stakeholder in the content, for said printing by the consumer in accordance with estimated consumer printing costs; and

c) providing printing consumables to the consumer at a discount in accordance with the estimated printing costs.

In accordance with a yet further aspect of the invention, there is provided a business method wherein a discount consumer printing service provider provides a discount printing service for consumers of viewable content, the service including the provision of information enabling a printing consumables provider to provide to respective said consumers printing consumables at a discount substantially proportional to operational costs of printing by the respective consumers of specified viewable content, for thereby encouraging the consumers to print the specified content.

In accordance with a yet further aspect of the invention, there is provided a business method, wherein a printing consumables provider provides for a content provider a discount service to consumers of viewable content, in which service the printing consumables provider provides printing consumables at a discount to the consumers, the discount being directly related to the respective consumers' costs incurred in printing content specified by the content provider as printable at a discount, whereby the consumers are encouraged to print the content.

There is thus facilitated the provision of a service whereby a consumer, a content stakeholder, for example a content generator and/or website provider, and a provider of printing consumables interact for mutual benefit.

A win-win situation is facilitated for parties involved in supplying and receiving printed information. For example, content stakeholders can benefit because content consumers who generally view most content on a display screen may be persuaded to print hard copies of specified content. This tends to reduce the need for costly commercial printing of hard copies and/or mailing costs, and tends to ensure that only interested consumers receive printed specified content. The consumer can benefit by being enabled to receive free or partially discounted print consumables, thereby offsetting printing costs, and the necessity for poorly targeted mailings may be reduced.

A printing consumables provider may also benefit because of a tendency to increase consumer printing volume and thus increase demand for printing consumables, and because a printing related discount is likely to attract consumers to that provider. A discounted printing service may be effected directly by a printing consumables provider or, alternatively, a discounted printing services provider can benefit by charging a content stakeholder for the service.

In accordance with a still further aspect of the invention, there is provided a method for use in a consumer printing discount service, comprising causing information to be provided in association with viewable content, said information communicating to a viewer that specified content, comprising or related to the viewable content, is printable by the consumer at a discount directly related to costs incurred by the consumer in printing said specified content.

In accordance with a yet further aspect of the invention, there is provided a method of providing viewable content, enabling discounted printing of specified content by an information consumer in possession of printing apparatus, user input apparatus and display apparatus, the method comprising:

a) providing information, for display by the display apparatus, for informing consumers that discounts are available on printing consumables in return for printing specified content;

b) said information including a graphical user interface (GUI) having a control element activatable by the user input apparatus so as to communicate with a discount service provider.

This facilitates quick and convenient identification and selection of content printable at a discount, and/or activation of a discount printing service.

### DESCRIPTION OF THE DRAWINGS

In order that the invention may be well understood, various embodiments thereof will now be described, by way of example only, with reference to the accompanying drawings, in which:

FIG. 1 shows schematically various parties and system elements for implementing a discounted consumer printing service in accordance with various embodiments of the invention;

FIG. 2 is a schematic diagram illustrating a process for implementing a discounted printing service in accordance with a first embodiment of the invention;

FIG. 3 is a schematic diagram illustrating a process for implementing a discounted printing service in accordance with a second embodiment of the invention;

FIG. 4 is a schematic diagram illustrating a process for implementing a discounted printing service in accordance with a third embodiment of the invention; and

FIG. 5 is a schematic diagram illustrating a process for implementing a discounted printing service in accordance with a fourth embodiment of the invention.

### DETAILED DESCRIPTION OF THE EMBODIMENTS

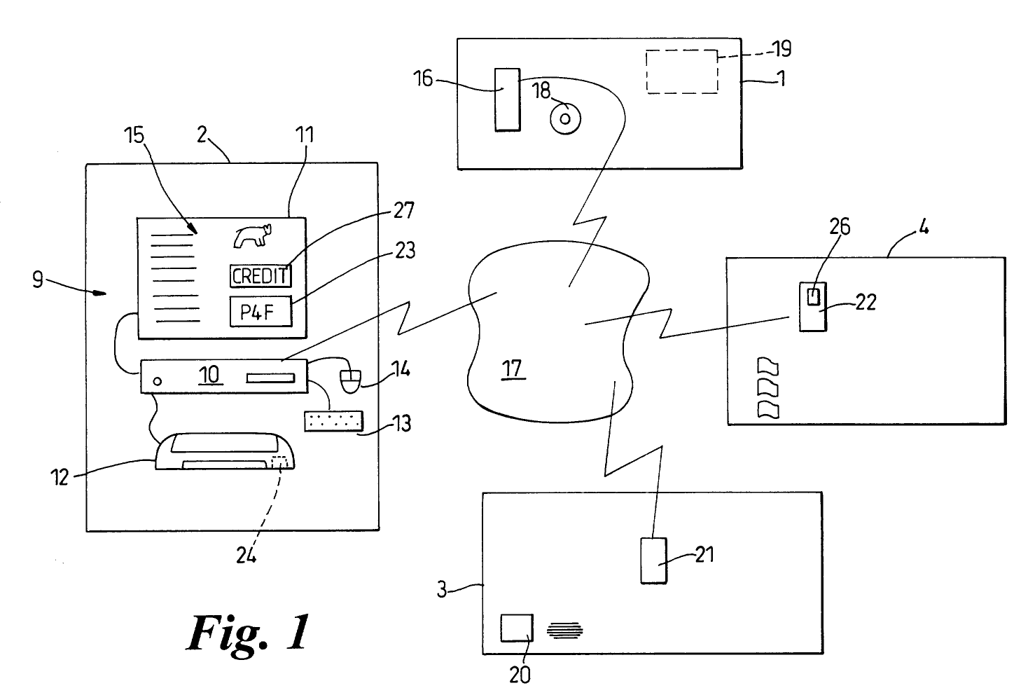

FIG. 1 shows schematically a content provider 1, a consumer 2 of viewable content, a provider 3 of print consumables, and a discounted consumer printing service provider 4 which provides services for enabling the other parties 1, 2, 3 to implement various aspects of a discounted printing process described in further detail below.

The consumer 2 possesses a computing system 9 comprising computer apparatus in the form of a personal computer (PC) 10, display means in the form of a monitor having a display screen 11, printing apparatus in the form of a printer 12, and user input apparatus in the form of a keyboard 13 and mouse 14, for inputting user commands to the PC 10. The PC 10 is connectable to a communications network such as the internet 17 for communication with the content provider 1.

The term consumer as used herein relates to a person who wishes to print material for his own personal use, using printing apparatus that he is financially responsible for supplying with printing consumables. For example, the consumer 2 may print locally at home using a home computing system 9, or may send digital content from remote computer apparatus to printing apparatus located at home. The term consumer also includes personnel from a business entity printing content, for consumption by the business, on printing apparatus for which the business entity is financially responsible. The term consumer printing is to be understood accordingly. However, the terms consumer and consumer printing are not intended to relate to commercial printing of content for financial gain, whereby the printed content is consumed by a third party that is not responsible for the costs of printing.

The content provider 1 provides electronic content (e-content) in the form of web pages 15 to the consumer's PC for temporary display on the screen 11. The content may take any suitable alternative form, and may include, for example, content in other formats, such as PDF, linked to the web pages. The content provider 1 arranges for content to be stored on computer storage apparatus in the form of at least one content server 16 for communication to the consumer's PC across a communication network, including for example the internet 17. Alternatively or additionally, e-content is stored on a content carrier such as a CD ROM 18 or alternative digital information storage device and physically delivered to the consumer 2, for example by mail, for loading onto the PC through a CD drive.

The content 15 may be generated directly by the content provider 1 or alternatively by a third party 19. For example, the content provider 1 is a large travel agency which prepares or procures content in the form of brochures advertising its present offerings. Alternatively, for example, the content provider 1 makes content available on behalf of others as its main business, and the content is generated by the third party 19, for example in the form of a smaller travel agency or other business requiring to advertise its products or services. Any party having an interest in persuading a consumer to consume content will be described herein as a stakeholder in that content. The stakeholder will primarily be the party generating the content, which may be the content provider 1 or third party 19.

The printing consumables provider 3 takes orders from the consumer 2 when required for supplying at least one type of printing consumable 20, for example ink cartridges for ink jet printers, toner cartridges for laser printers, ink or toner for refilling such cartridges, paper or other sheet-like printable media or any other product or substance which is depleted during printing activity. The printing consumables provider 3 is equipped for electronic commerce (e-commerce), and has a computerised ordering system including computing apparatus 21 for communicating with consumers 2 over a communication network such as the internet 17.

The discounted consumer printing service provider 4 manages computing apparatus 22 arranged to communicate with the other parties over a communication network, for example the internet 17, for facilitating discounted printing by the consumer 2 of viewable content provided by the content provider 1. The service provider 4 is shown separately, but will in many instances be an integral part of the printing consumables provider's business. The computer apparatus can take any convenient form, and may comprise separate and geographically distributed interconnected devices.

The content provider 1 includes, with the data representing each web page, identification data relating to whether the page content is presently available for printing at a discount by the consumer 2. The identification data can be included using any suitable method which enables computer processing apparatus to recognise (identify) the data, for example data signatures and certificates. Selected content which has been designated as printable by the consumer at a discount is referred to herein as specific content. The identification of specific content enables automatic processing of the specific content in a discounted printing system, that is, without a requirement for human intervention.

The content server 16 is adapted to generate, automatically on receiving data identifying content as designated for discount printing, visual information associated with the content for communicating to the consumer 2 the offer of the printing discount. The visual information is displayed with the specific content or, alternatively, is related to the content in some other way, for example by referring to specific content contained in other content such as other web pages.

The web page 15 shown in FIG. 1 includes visual information in the form of an active graphical user interface (GUI) control element comprising a button, or icon, 23 activatable by the keyboard 13, mouse 14 or some other user input arrangement, for example voice operated input apparatus. In FIG. 1, the button 23 is displayed with the specific content ie with the web page 15. In a modification of this embodiment, a descriptor web page contains information describing at least one associated web page which is printable at a discount directly by activating a further button (not shown), similar to button 23, displayed in the descriptor page. Optionally, the described web page is printed without opening it for display on the display screen 11.

In the embodiment shown in FIG. 1, a full discount of all printing costs is offered, and the discount printing service is thus referred to as a free printing service. The button 23 is accordingly marked “Print-4-Free”, “P4F” or similar.

The computer system 9 is adapted to communicate with the computer apparatus 22 of the discounted printing service provider 4, the content server 16 and the computer apparatus 21 of the printing consumables provider 3 by means of a communications module 24 adapted for secure communications, for example using SSL (secure socket layer). The module 24 is programmed to recognise content identified as available for discounted printing and is adapted to capture and store relevant data from printed content at the time of printing that content.

The module may be implemented in software or in hardware, and as shown is embedded in the printer 12. In a modification, the module is incorporated in a printer driver loaded on the PC 10. However, the module is alternatively a separate device connected to another component of the computer system, for example a slot-in card or other plug-in device. In a further alternative modification, the module forms an integral part of another component of the system. The module 24 may be implemented in any other convenient manner, for example with part of its functionality effected in one of the above-described forms and another part of its functionality effected in another of the above-described forms.

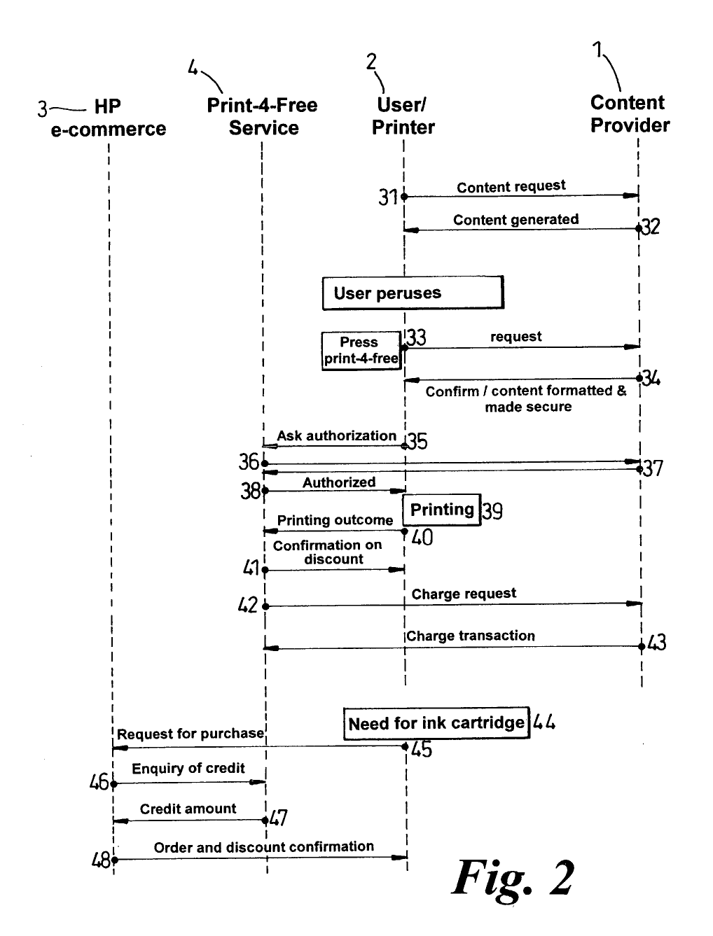

FIG. 2 illustrates a method of operating a discounted consumer printing service, process steps being shown in chronological sequence from top to bottom. At step 31 the consumer (user) 2 inputs commands to the PC 10 to request over the internet 17 content from the content server 16, which is duly provided (step 32) in world wide web format (HTTP). Clearly, the service could be provided using any alternative suitable communication format or protocol as desired.

The consumer (user) 2 views the content, and is informed of the print-for-free offer, for example by the presence of the print-4-free button 23. The consumer will, in this manner, be encouraged to print the material on the consumer's printer 12. This is a particularly efficient way for the content provider 1 to provide consumers 2 with marketing and advertising material, for example. In contrast to targeted mailing, production of hard copy, administration, distribution and mailing costs are saved. Furthermore, only consumers who are presently interested in a product will take up the printing offer, particularly since only the cost of printing is discounted, with no additional financial incentive. This produces further savings in unnecessary materials, thus also benefiting the environment. Still further, information is delivered to the consumer conveniently when required.

When button 23 is pressed, a request is sent to the content provider 1 to provide the content (step 33). The content provider 1 replies to confirm the request (step 34). Any necessary formatting of content is carried out at this time.

The module 24 generates a request for authorisation to the discount printing service provider 4 (step 35). The module extracts relevant data from the content, including identification data, and sends it to the computing apparatus 22. Alternatively, the data is forwarded to the service provider 4 for extracting relevant details therefrom. The data includes information regarding the printer and cartridge type. The service provider 4 may authorise discounted printing only if authorised cartridges or printers are used. For example, printers may be registered by serial number, and discounted printing authorised only when the discounted printing service provider 4 receives a signal from the module 24 at the time of printing which confirms the use of a registered printer. This encourages use of equipment authorised by the service provider 4, which may be restricted to equipment provided by the print consumables provider 3.

The service provider 4 then uses the information to check present authorisation of the specific content with the content provider 1 (step 36). This is useful where content is dynamically discounted, that is, discounted for one or more limited time periods only, or under certain other conditions.

If discounted printing is authorised, the computer apparatus 22 sends a signal for receipt by the computer system 9 authorising discounted printing. In the embodiment of FIG. 2, the signal is passed to the module 24 which causes the printer 12 to print the specific material automatically (step 39). Alternatively, the module enables printing on a further user command.

When printing is complete, the printing outcome is reported by the computer system 9 to the service provider 4 (step 40). The report confirms the content actually printed and furthermore contains data collected by the module 24 for use in estimating the actual costs of the printing event to the consumer 2. The collected data includes, for example, the amount and type of ink and the quantity and type of printable media, such as paper and overhead transparencies, used in the printing, and usage details of any other printing consumable as required. The collected data further includes at least one of: the type of printer and print cartridge used and a unique identifier for the printer 12.

The data from the report is received, processed and stored in an account 26 by the computing apparatus 22. Alternatively, the data is at least partially processed by the module 24 and/or the PC 10 before sending to the computing apparatus 22. The processing results in an estimation of the actual costs incurred by the consumer for printing the specific content. The precise method of calculation can be varied as desired. Printer amortisation costs are optionally included ie the printer 12 is treated as a consumable for the purposes of the estimation. Estimated costs of printing events are stored in the account 26. Following printing 39, the consumer 2 may be automatically informed (step 41) of the estimated printing costs, and also of the cumulative total costs stored against his account and not redeemed. Alternatively, a further GUI control element is provided in the form of a further button, or icon, 27 which is activatable by a user input device 13, 14 to trigger notification of unredeemed total printing costs credited to the account 26.

Following the printing event, a charge is automatically raised (step 42) with the content provider 1 and the charge settled in an automated fashion (step 43). Where the content provider 4 includes a third party 19, the third party may be billed directly if appropriate. It should be noted that the content provider 1 is billed after delivery, and only for specific content actually “delivered” in hard copy to interested consumers. The content provider is assured it is not paying for ill-targeted deliveries.

Clearly, immediate and automatic settlement is not essential, and many other ways and times of settling the charge from the service provider 4 to the content provider 1 will be apparent to the skilled reader. Indeed, where the discounted printing service provider 4 and printing consumables provider 3 are integral or affiliates, no charge may be necessary if, by virtue of the discounted printing service, sufficient additional demand is generated for printing consumables from the printing consumables provider.

When the consumer 2 identifies a need (step 44) for replacement printing consumables 20, for example an ink cartridge, he will have an incentive to direct his purchase request (step 45) to the printing consumables provider 3 who is offering a discount via the discounted printing service 4, thus providing additional business to the consumables provider 3 and differentiating the consumables provider's services from those of its competitors. In one aspect of the embodiment, such requests are only possible over e-commerce channels, although in other aspects other sales and distribution channels may also be provided.

The consumables provider 3 interrogates (step 46) the computer apparatus 22 of the discount printing service 4 to determine (step 47) from the account 26 of the user what discount should be applied to the ink cartridge. Because discounts are realisable in proportion to the costs incurred and only against printing consumables, spurious printing of content which may otherwise be of little interest to the consumer, merely to obtain some sort of credit or reward, is discouraged. The printing consumables provider 3 is then able to confirm the order and the discount (step 48).

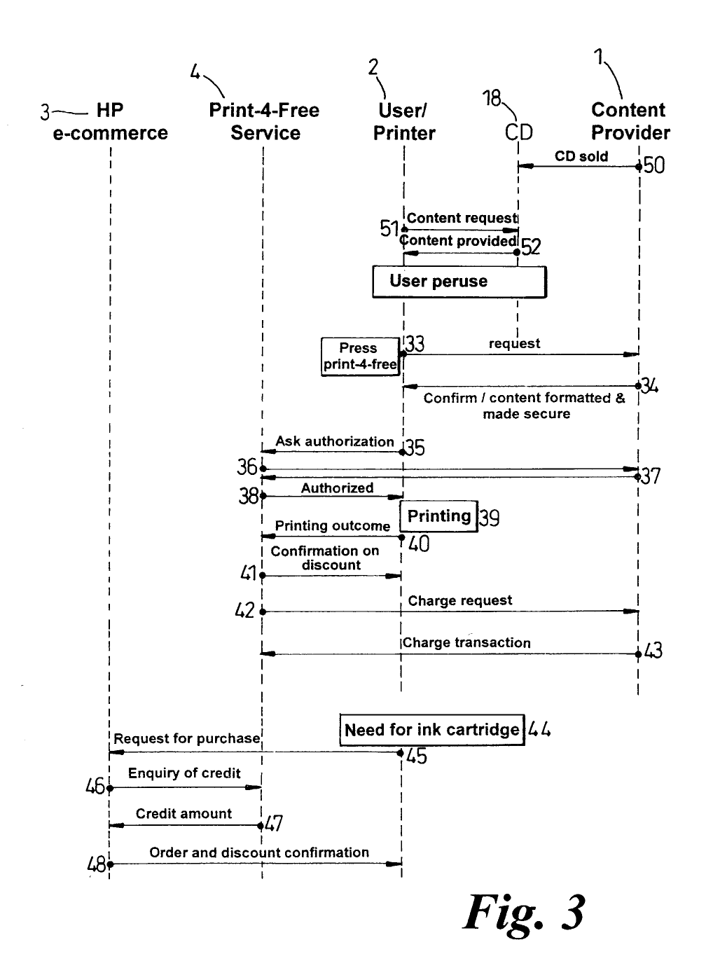

Referring now to FIG. 3, a second embodiment is shown. To avoid unnecessary duplication of effort, steps which are substantially similar to those described with reference to FIG. 2 retain the same reference signs and are not described again in detail. In a modification to the process shown in FIG. 2, the content provider 1, or the third party 19 in association with the content provider 1, provides (step 50) content carried on a carrier in the form of a compact disc (CD) 18 or any other convenient means of carrying computer-readable information. The CD may be sold or given away, for example as part of a promotion. The content could be carried on a carrier provided for another purpose by another party, for example alongside a game carried on CD. Content can then be generated on screen 11 by the consumer 2 from the CD 18 on request (steps 51 and 52). Following review of the information, the process continues as described with reference to FIG. 2.

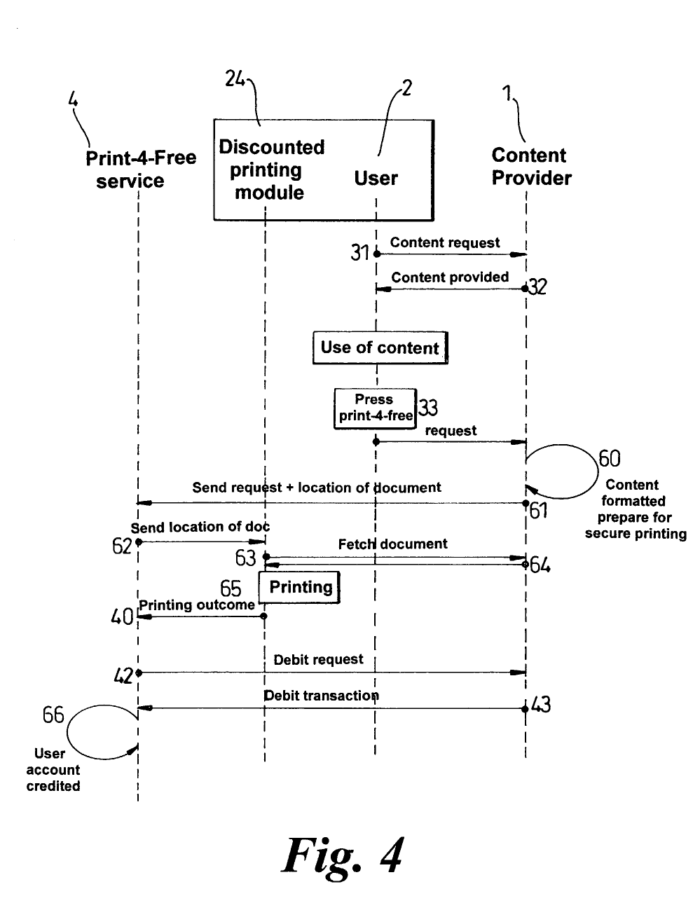

Referring now to FIG. 4, a third embodiment is shown. To avoid unnecessary duplication of effort, steps which are substantially similar to those described with reference to FIG. 2 retain the same reference signs and are not described again in detail. The module 24 monitors messages from the discounted printing service provider 4. When a consumer 2 activates the button 23, the content provider 1 is notified by secure request (step 33). The content provider 1 formats the content and prepares it for secure printing (step 60), then notifies the discounted printing service provider 4 that the content is ready (step 61), giving the content's location, for example the content's URL. In turn the discounted printing service provider 4 notifies the module 24 of the availability of the content and its location (step 62). The module 24 causes the PC 10 to request the content from the given location (step 63).

The content is consequently transmitted (step 64) by the content provider 1 for secure downloading and printing (step 65) by the consumer 2. Following reporting of the printing outcome (step 40) by the module 24 to the discounted printing service provider 4, the user account 26 is credited (step 66) with the discount by the discounted printing service provider 4. Discounting of printing consumables can then be effected as described above with reference to FIG. 2.

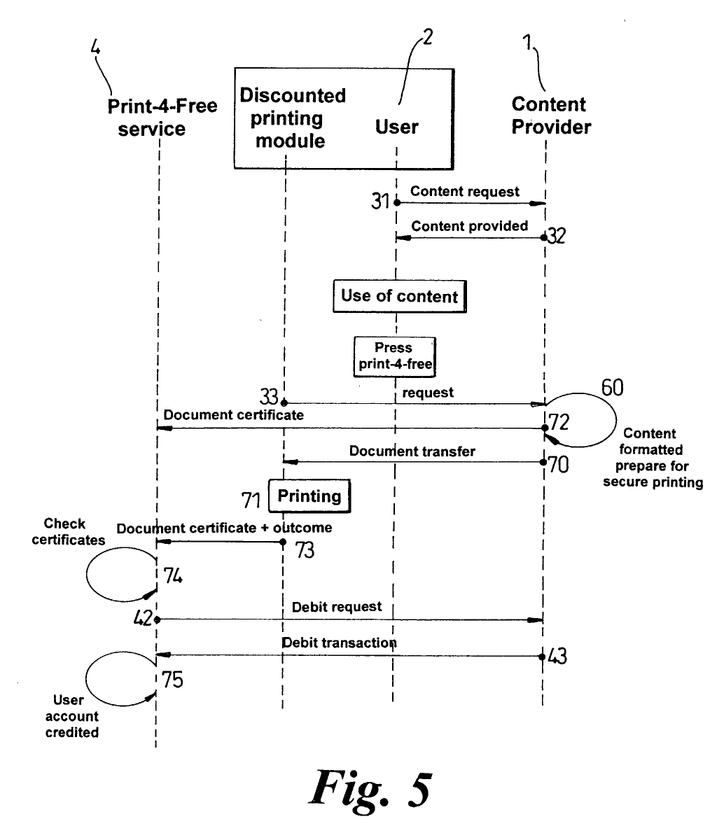

Referring now to FIG. 5, a fourth embodiment is shown. To avoid unnecessary duplication of effort, steps which are substantially similar to those described with reference to FIGS. 2 and 4 retain the same reference signs and are not described again in detail. When the consumer 2 activates the button 23, the module 24 and the content server 16 enter a secure communication whereby the content is formatted (step 60), sent (step 70) and printed (step 71) under control of the module 24. Meanwhile the content server 16 issues a security certificate and sends it to the discounted printing service provider 4 (step 72).

The security certificate is matched by a similar certificate sent by the module 24 to the discounted printing service provider 4 along with printing cost information to confirm the successful outcome of the printing job (step 73). The certificates are compared by the discounted printing service provider 4 (step 74) and the credit to the consumer account 26 is increased (step 75). Discounting of printing consumables can then be effected as described above with reference to FIG. 2.

The embodiments described above facilitate discounted, including effectively free, printing by a consumer at a time and location which is convenient to him. The consumer sees a direct correlation between a discount and an amount of discounted content printed on an authorised printer. A content provider can distinguish itself from or compete more effectively with competitors, for example by offering a print-for-free brochure on its web site, in the same way free-phone numbers are sometimes offered.

It will be apparent from the above that aspects of the above-described embodiments facilitate offering by a printer or ink cartridge manufacturer or a large ink cartridge distributor, for example, of a print-for-free service at a point of consumption to a provider of printable content, thereby facilitating a content provider's user to print designated content effectively without incurring ink or other printing consumable costs.

Aspects of the above-described embodiments also facilitate debiting of a third party by the printer or ink cartridge manufacturer or large ink cartridge distributor for the cost of ink or other printing consumable incurred in printing by content users of particular content designated by the third party on a permanent or dynamic basis as suitable for free printing. The embodiments can conveniently employ a printing system that can securely identify a designated document as printable for free, can notify a further system that the document has been printed correctly (or not), and the estimated cost of the printing.

1. A method for discounting printing, comprising:
a) receiving information about printing by a consumer of content that has been
i) selected by the consumer for printing and
ii) specified by a content provider as printable at a discount;
b) obtaining, for use in discounting printing consumables, an estimation of printing costs incurred by the consumer in said printing of the selected content; and
c) preparing a bill, using said estimation, for billing a stakeholder in the content for said printing.

2. A method as claimed in claim 1, comprising using said information about consumer printing to prepare said estimation of printing costs.

3. A method as claimed in claim 1, comprising effecting said billing after provision to the consumer of the discounted printing consumables by a consumables provider.

4. A method as claimed in claim 1, comprising effecting said billing automatically following said obtaining of said estimation.

5. A method as claimed in claim 1, comprising billing said content provider.

6. A method as claimed in claim 1, comprising crediting a printing consumables provider an amount in accordance with said estimation of printing costs, for providing the printing consumables to the consumer at a discount.

7. A method as claimed in claim 1, comprising providing printing consumables at a discount in accordance with said estimation of printing costs.

8. A method as claimed in claim 7, wherein the discount is provided when a consumer orders a replacement printing consumable from a printing consumables provider.

9. A method as claimed in claim 1, wherein the estimation of printing costs is stored automatically and electronically in an account associated with a consumer and/or at least one printing apparatus of the consumer.

10. A method as claimed in claim 9, comprising providing information to a printing consumables provider regarding a total discount value presently credited to an account associated with the consumer and/or the printing apparatus.

11. A method as claimed in claim 1, wherein the estimation of printing costs is at least partly based on information, accessed directly from printing apparatus financially maintained by the consumer, relating to at least one selected from the following: an amount of ink used to print said content; a quantity of paper or similar media used to print said content on; and amortisation costs for the printing apparatus.

12. A method as claimed in claim 1, wherein the estimation of printing costs is effected by printing apparatus financially maintained by the consumer.

13. A method as claimed in claim 1, comprising automatically informing a consumer of an estimated value of the printing costs incurred by the consumer for printing said content.

14. A method as claimed in claim 1, comprising automatically ascertaining whether a discount is allowable for content selected by the consumer, including remotely gathering data, prior to authorising a discounted printing event, about a consumer printing apparatus presently connected for printing the selected content and/or an ink cartridge used in the printing apparatus.

15. A method as claimed in claim 1, comprising automatically ascertaining whether a discount is allowable for printing content selected by the consumer, including interrogating data provided by a content provider as to whether the selected content is presently specified as printable at a discount.

16. A method as claimed in claim 1, wherein at least some content is specified on a dynamic basis by a content provider as printable at a discount.

17. A discounted printing service, for facilitating discounted printing of content by a consumer on printing apparatus for which the consumer is financially responsible, comprising:
a) receiving information about printing by the consumer of selected content which has been specified by a content provider as discounted printing content;
b) billing the content provider, or other stakeholder in the content, for said printing by the consumer in accordance with estimated consumer printing costs; and
c) providing printing consumables to the consumer at a discount in accordance with the estimated printing costs.

18. A discounted printing service as claimed in claim 17, wherein said discount covers substantially all the estimated printing costs, thereby effectively providing a substantially free consumer printing service.

19. A discounted printing service as claimed in claim 17, wherein the service is initiated by activating a graphical user interface control element displayed in connection with said content.

20. A method for use in a consumer printing discount service, comprising causing information to be provided in association with viewable content, said information communicating to a viewer that specified content, comprising or related to the viewable content, is printable by the consumer at a discount directly related to costs incurred by the consumer in printing said specified content.

21. A method as claimed in claim 20, wherein said information comprises a graphical user interface element displayed together with the viewable content, said element being activatable by a user input device so as to initiate the printing discount service.

22. A method as claimed in claim 20, wherein said information communicates to a viewer that specified content can be printed effectively at no cost to the consumer.

23. A method as claimed in claim 20, wherein the discount is provided by a printing consumables provider to the consumer when the consumer orders a printing consumable from the printing consumables provider.

24. A business method wherein a discount consumer printing service provider provides a discount printing service for consumers of viewable content, the service including the provision of information enabling a printing consumables provider to provide to respective said consumers printing consumables at a discount substantially proportional to operational costs of printing by the respective consumers of specified viewable content, for thereby encouraging the consumers to print the specified content.

25. A business method, wherein a printing consumables provider provides for a content stakeholder a discount service to consumers of viewable content, in which service the printing consumables provider provides printing consumables at a discount to the consumers, the discount being directly related to the respective consumers' costs incurred in printing content specified by the content provider as printable at a discount, whereby the consumers are encouraged to print the content.

26. A business method as claimed in claim 25, wherein the discount is calculated to recompense the respective consumers for substantially all the estimated costs incurred by them in printing the specified content, whereby the service can be fairly promoted as a print-for-free service.

27. A method of providing viewable content, enabling discounted printing of specified content by an information consumer in possession of printing apparatus, user input apparatus and display apparatus, the method comprising:
a) providing information, for display by the display apparatus, for informing consumers that discounts are available on printing consumables in return for printing specified content;
b) said information including a graphical user interface (GUI) having a control element activatable by the user input apparatus so as to communicate with a discount service provider.

28. A method as claimed in claim 27, wherein the control element is a GUI button labelled to indicate a link with an effectively substantially free printing service.

29. A method as claimed in claim 27, comprising providing a further control element activatable, after printing of the specified content on the printer, to initiate retrieval from the service of information regarding an actual discount assigned to the consumer and/or the printing apparatus in respect of said printing.

30. Printing apparatus operable to detect content which has been specified by a content provider as discounted printing content, for use in a method as claimed in clam 1.

31. A computer system operable to electronically implement discounted printing of content by a consumer in accordance with a method as claimed in claim 1 without human intervention in response to activation of a GUI control element.

32. Computer apparatus for facilitating discounted printing by a consumer of viewable content, comprising:
a) means for receiving information about printing by the consumer of content, specified by a content provider as discounted printing content; and
b) means for assessing printing costs incurred by the consumer for printing the specific content, for use in discounting printing consumables provided to the consumer.

33. A method comprising:
a) receiving information about printing by a consumer of content that has been
i) specifically selected by the consumer for printing and
ii) specified by a content provider as printable at a discount;
b) using the information in an estimation, for use in discounting printing consumables, of printing costs incurred by the consumer in said printing of the selected content; and
c) billing a stakeholder in the content for said printing substantially in proportion to the estimated printing costs.

34. A method for discounting printing, comprising:
a) receiving information about printing by a consumer, using printing apparatus for which the consumer is financially responsible, of content that has been
i) selected by the consumer for printing and
ii) specified by a content provider as printable at a discount; and
b) obtaining, for use in discounting printing consumables, an estimation of printing costs incurred by the consumer in said printing of the selected content; wherein
c) said estimation is based on operational data collected from said printing apparatus.
